(19) United States
(12) Patent Application Publication
(10) Pub. No.: US 2016/0187633 A1
(43) Pub. Date: Jun. 30, 2016

(54) DUAL OBLIQUE VIEW SINGLE PLANE ILLUMINATION MICROSCOPE

(71) Applicant: Applied Scientific Instrumentation Inc., Eugene, OR (US)

(72) Inventor: Gary D. RONDEAU, Eugene, OR (US)

(21) Appl. No.: 14/742,670

(22) Filed: Jun. 17, 2015

Related U.S. Application Data
(60) Provisional application No. 62/096,840, filed on Dec. 24, 2014.

(51) Int. Cl. G02B 21/00; G02B 21/02

(52) U.S. Cl. CPC G02B 21/0032; G02B 21/0076; G02B 21/02; G02B 21/008

(57) ABSTRACT

A microscope includes an optical assembly including a first objective; and, another optical assembly including a second objective; wherein the first objective and the second objective are configurable to be oriented in an oblique angle relative to each other to provide for illumination and observation of a specimen. A method of fabrication and a controller are disclosed.

### BACKGROUND OF THE INVENTION

1. Field of the Invention

The invention disclosed herein relates to the field microscopy and in particular to microscopes that employ single plane illumination and use two objectives.

2. Description of the Related Art

Light sheet fluorescence microscopy (LSFM) is a fluorescence microscopy technique that provides good optical sectioning capabilities and high speed. In LSFM, only a thin slice (usually a few hundred nanometers to a few micrometers) of the sample is illuminated perpendicularly to the direction of observation. For illumination, a light-sheet that is generated by the laser may be used. Another method uses a circular beam scanned in one direction to create the light sheet. As only the actually observed section is illuminated, this method reduces the photodamage and stress induced on a living specimen. Also the good optical sectioning capability reduces the background signal and thus creates images with higher contrast, comparable to confocal microscopy. Because LSFM scans specimens by using a plane of light instead of a point (as in confocal microscopy), LSFM can acquire images at speeds 100 to 1000 times faster than those offered by point-scanning methods.

Improvements made to LSFM include selective or single plane illumination microscopy (SPIM). Also single plane illumination microscopy (SPIM) can provide sub-cellular resolution. Generally, single plane illumination microscopy (SPIM) makes use of orthogonal plane fluorescence optical sectioning microscopy or tomography. Unfortunately, the requirement to maintain orthogonal planes imposes various other optical limitations on present day single plane illumination microscopy (SPIM) systems.

Thus, what are needed are methods and apparatus to improve the flexibility of single plane illumination microscopy (SPIM) systems.

### SUMMARY OF THE INVENTION

In a first embodiment, a microscope is provided. The microscope includes: an optical assembly including a first objective; and, another optical assembly including a second objective; wherein the first objective and the second objective are configurable to be oriented in an oblique angle relative to each other to provide for illumination and observation of a specimen.

In another embodiment, a method for fabricating a microscope is provided. The method includes: selecting a frame; and, incorporating an optical assembly including a first objective and another optical assembly including a second objective; and, configuring the first objective and the second objective to be oriented in an oblique angle relative to each other to provide for illumination and observation of a specimen.

In a further embodiment, a controller for a microscope is provided. The controller includes: a set of computer executable instructions stored on non-transitory computer readable media, the instructions for operating an optical assembly including a first objective and another optical assembly including a second objective; and orienting the first objective and the second objective in an oblique angle relative to each other to provide for illumination and observation of a specimen.

### BRIEF DESCRIPTION OF THE DRAWINGS

The features and advantages of the invention are apparent from the following description taken in conjunction with the accompanying drawings in which:

FIG. 1 is a cut-away perspective illustration depicting exemplary aspects of a sample chamber used in light sheet microscopy;

FIG. 2 is a side view of an exemplary aspects of a single plane illumination microscopy (SPIM) configured with orthogonally oriented objectives;

FIGS. 3A and 3B, collectively referred to as FIG. 3, is a schematic diagram depicting aspects of a single plane illumination microscopy (SPIM) system;

FIG. 4 is an exploded view diagram depicting aspects of a horizontal implementation of the single plane illumination microscopy (SPIM) system configured according to the teachings herein;

FIG. 5 is an exploded view diagram depicting aspects of a vertical implementation of the single plane illumination microscopy (SPIM) system configured according to the teachings herein;

FIG. 6 is a side view of an embodiment of the single plane illumination microscopy (SPIM) system configured according to the teachings herein were angular relationships of the objectives may be seen in relation to other portions of the single plane illumination microscopy (SPIM) system;

FIG. 7 is a perspective cut-away illustration of the single plane illumination microscopy (SPIM) system configured according to the teachings herein, wherein some components have been omitted for clarity; and,

FIG. 8 depicts aspects of a control system for controlling the microscope.

### DETAILED DESCRIPTION OF THE INVENTION

Disclosed herein are methods and apparatus that provide a dual oblique-view single plane illumination microscopy (SPIM) system. The dual oblique-view single plane illumination microscope is an optical fluorescence microscope that uses light sheet illumination. A thin light sheet is project through a sample, at a focal point and perpendicular to the optical axis of the observation microscope objective. Three dimensional volume imaging is accomplished by moving the specimen through the illuminated light sheet, one plane at a time, while acquiring sectional images. Advantageously, the microscope objectives may be at oblique angles in relationship to each other, and therefore provide greater optical performance.

In order to provide some context for the teachings herein, some fundamental aspects of single plane illumination microscopy (SPIM) are introduced.

As discussed herein, the term “light sheet” generally refers to light beam that is shaped in a thin plane. The light beam may be shaped as the thin plane by an optical system, and need not be planar other than at the point of illumination of the specimen. Commonly, the light sheet is generated with a cylindrical lens and the focused sheet is projected to the specimen using a microscope objective. The light beam may be generated by any source deemed appropriate. For example the light beam may be generated by a laser.

As discussed herein, the term “objective,” “objective lens” and other similar usages of “objective” generally refer to the first component of a microscope that receives light as the light proceeds from the specimen to the image plane. Major microscope manufacturers offer a wide range of objective designs, which feature excellent optical characteristics under a wide spectrum of illumination conditions. Many types of objectives have front lens elements that allow them to be immersed in water, glycerin, or a specialized hydrocarbon-based oil.

Generally, three design characteristics of the objective set the ultimate resolution limit of the microscope. These include the wavelength of light used to illuminate the specimen, the angular aperture of the light cone captured by the objective, and the refractive index in the object space between the objective front lens and the specimen. Resolution for a diffraction-limited optical microscope can be described as the minimum detectable distance between two closely spaced specimen points, as provided in Eq. (1):

R=λ/2n(sin(θ)) (1);

where R represents separation distance, λ represents illumination wavelength, n represents the refractive index for the imaging medium, and θ is one-half of the objective angular aperture. Eq.(1) shows that resolution is directly proportional to the wavelength of the illumination source (which is usually in the visible region of between about 400 nanometers to about 700 nanometers). Resolution is also dependent upon the refractive index of the imaging medium and the objective angular aperture. Objectives are designed to image a given specimen either with air or a medium that exhibits a higher refractive index between the front lens and the specimen. The field of view is often quite limited, and the front lens element of the objective is placed close to the specimen with which it must lie in optical contact. A gain in resolution by a factor of approximately 1.5 is attained when immersion oil is substituted for air as the imaging medium.

Perhaps the most important factor in determining the resolution of an objective is the angular aperture, which has a practical upper limit of about 72 degrees (with a sine value of 0.95). When combined with refractive index, the product (provided as Eq. (2)) is known as the numerical aperture (NA), and provides an indicator of the resolution for any particular objective:

n(sin(θ)) (2).

The numerical aperture (NA) is arguably the most important design criteria to consider when selecting a microscope objective. Values range from 0.1 for very low magnification objectives (1×to 4×) to as much as 1.6 for high-performance objectives that make use of specialized immersion oils. As values for the numerical aperture (NA) increase for a series of objectives of the same magnification, a greater light-gathering ability and increase in resolution is achieved.

As discussed herein, the term “single plane illumination microscope (SPIM)” generally refers to an optical fluorescence microscope that uses light sheet illumination. A thin light sheet is project through a sample, at the focus and perpendicular to the optical axis of the observation microscope objective. Three dimensional volume imaging is accomplished by moving the sample through the illuminated light sheet, one plane at a time, while acquiring sectional images.

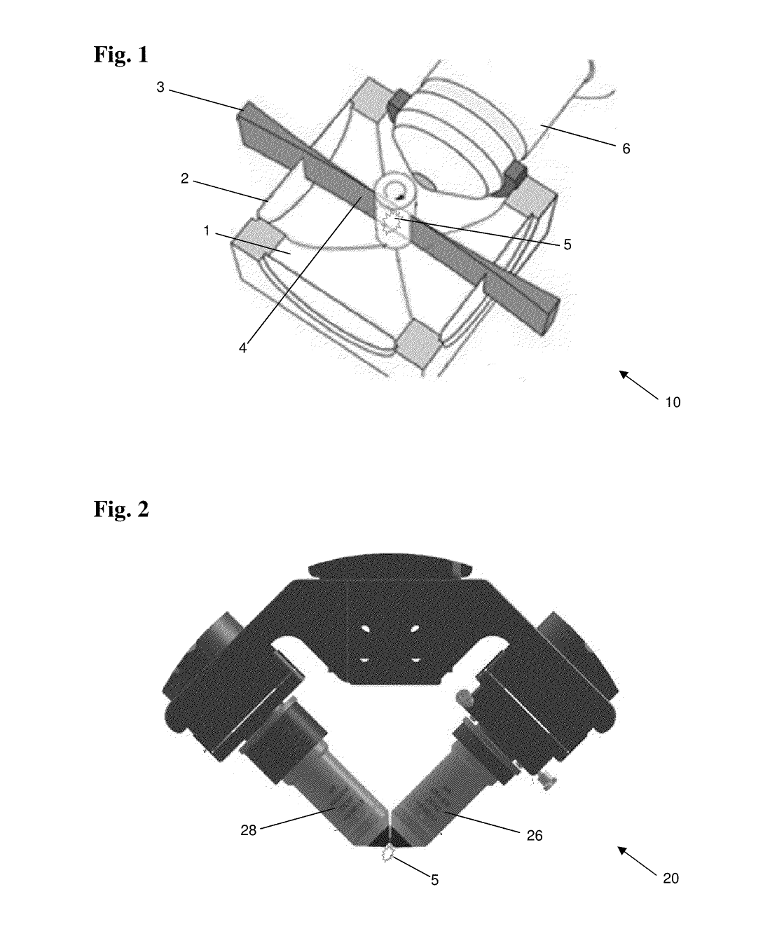

Refer to FIG. 1 where an exemplary sample chamber 1 of a microscope 10 is shown. The exemplary sample chamber 1 receives illumination 3 through an optical element such as window 2. The illumination 3 is focused into a light sheet 4, and illuminates a specimen 5 (the term “specimen” is generally synonymous with the term “sample” and may be used interchangeably herein). Illumination of the specimen 5 is observed through an objective 6. Very often, the specimen 5 is suspended in a media, such as agar. In some embodiments, the specimen 5 is contained in a transparent capillary.

Referring now also to FIG. 2, where aspects of a dual optic microscope 20 are shown. In this example, the dual optic microscope is configured as a vertical light sheet microscope, and provides for hosting the specimen 5 in a dish or on a slide. The dual optic microscope 20 includes a first objective 26 and a second objective 28. In some embodiments, the two objectives (26, 28) are used for illumination and imaging. That is, the first objective 26 and the second objective 28 do double-duty and alternately act as the light source to project the light sheet 4 and then as the objective to collect images. This technique allows for two perpendicular views of the specimen 5 to be obtained in rapid succession. Fusing the two perpendicular views numerically allows for enhanced isotropic optical resolution for the resulting three-dimensional volume images.

Biological samples are commonly imaged in an aqueous environment. For conventional, prior art SPIM microscopes, this requires a sample chamber 1 that allows for distortion-free optical propagation from the lens of each objective (26, 28) through the mounting media and to the specimen 5. As one might imagine, the mounting media must also be refractive index matching. A convenient way to achieve this condition is to use lenses for each objective (26, 28) that are designed for dipping in water. A pair of such objective lenses can be arranged perpendicular to one another, with the optical axis of each objective at +/−45 degrees, with respect to the horizontal. In this manner, the two objectives (26, 28) can be co-focused on a specimen 5 that is contained in a water-filled dish.

Geometric constraints impose limits on the types of objective lenses that can be used in the SPIM geometries such as provided in the dual optic microscope 20 described above. For the optical axes of the two objectives (26, 28) to be perpendicular, the included half-angles of the two objectives must total less than ninety (90) degrees. If the two objectives (26, 28) are identical for dual-view systems, then the included angle of each objective (26, 28) must be less than forty five (45) degrees. The numerical aperture (NA) of the particular objective specifies the optical included angle of acceptance for light into the lens. Table 1 shows the optical included angle and the physical included angle of some available commercial objectives for various numerical apertures (NA). The largest numerical aperture (NA) in a commercial objective that has an included angle of forty five (45) degrees or less is NA=0.8. An optical included angle of forty five (45) degrees implies a numerical aperture (NA) of 0.948, which imposes a theoretical limit on the maximum numerical aperture (NA) that a pair of objective lenses could have and still be placed perpendicular to each other while being co-focused.

TABLE 1
Objective Included Angles and Resolution

| Objective | Optical | Physical included angle | Theoretical |
|---|---|---|---|
| numerical | included | of commercially | transverse optical |
| aperture (NA) | angle, I_{O} | available objectives | resolution (μm) |
| 0.3 | 12.9 | 35 | 1.01 |
| 0.8 | 36.6 | 44.7 | 0.38 |
| 0.948 | 45 | None | 0.32 |
| 1.0 | 48.3 | 55-58 | 0.305 |
| 1.1 | 55.2 | 57-61 | 0.277 |
| 1.2 | 63.6 | 76 | 0.254 |

For a single-view light sheet microscope, the condition that the objectives be identical is moot. It is therefore possible to use one objective with a high numerical aperture (NA) for observation with a second objective having a lower numerical aperture (NA) to generate the light sheet. It is also common to sweep a Gaussian beam to create the light sheet. The focused Gaussian beam will have a focus profile characterized by a waist and a range that depends upon the numerical aperture (NA) of the focused beam. Table 2 below provides data describing properties of light sheets created by a Gaussian beam. As shown, beams with a larger numerical aperture (NA) produce tighter focus but of a shorter length than beams with a lower numerical aperture (NA). Table 2 shows how the sheet parameters will change with the numerical aperture (NA) of the scanned Gaussian beam.

TABLE 2
Gaussian Light Sheet Properties

| Numerical | Sheet beam | Beam waist | Beam range = |
|---|---|---|---|
| aperture (NA) | included | radius | 2*zr = 2 * π * |
| for light | angle, Iₛ | 0.85*λ/(2*NA) | waist\hat{ }2/λ |
| sheet beam | (degrees) | (μm) | (μm) |
| 0.40 | 23.58 | 0.5 | 3.5 |
| 0.30 | 17.46 | 0.7 | 6.3 |
| 0.20 | 11.54 | 1.1 | 14.2 |
| 0.15 | 8.63 | 1.4 | 25.2 |
| 0.12 | 6.89 | 1.8 | 39.4 |
| 0.10 | 5.74 | 2.1 | 56.7 |
| 0.08 | 4.59 | 2.7 | 88.7 |
| 0.06 | 3.44 | 3.5 | 157.6 |
| 0.04 | 2.29 | 5.3 | 354.7 |
| 0.03 | 1.72 | 7.1 | 630.5 |
| 0.02 | 1.29 | 9.2 | 1072.7 |

For specimens that are more than a few microns in size, the numerical aperture (NA) and the included angle of the scanned Gaussian beam must be relatively small for the beam to span the specimen without exhibiting significant divergence.

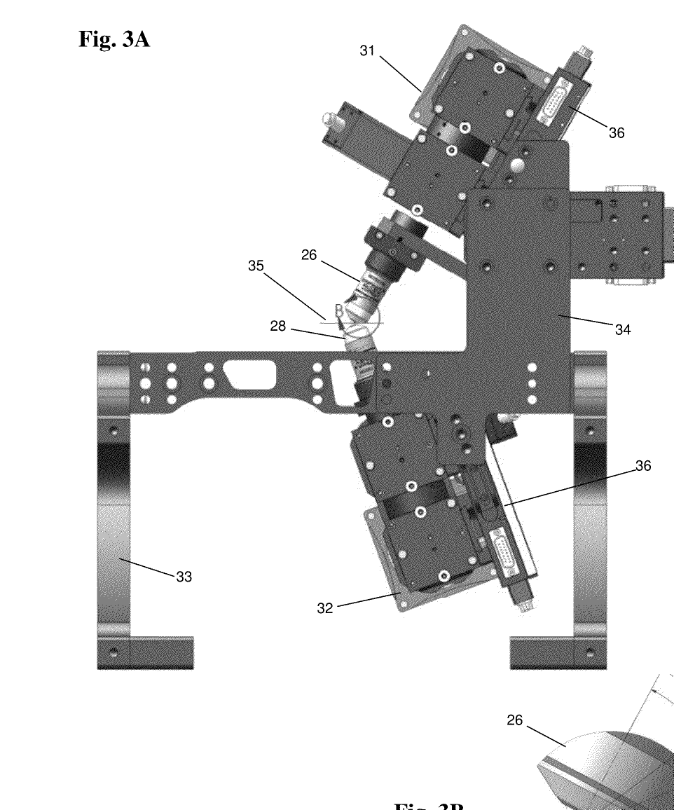

Referring now to FIG. 3, an exemplary embodiment of a dual oblique-view single plane illumination microscope 30 is shown. In the interest of brevity, the dual oblique-view single plane illumination microscope 30 is simply referred to as the “microscope” 30. Prior to discussing the theory of operation, components of the microscope 30 are introduced.

FIG. 3A provides a side view of the microscope 30, depicting only some of the major components of the microscope 30. As shown in FIG. 3A, the microscope 30 includes a frame 33. The frame 33 provides a mechanical base for mounting of other components. Mounted to the frame 33 is at least one mount 34. The at least one mount 34 may articulate in any manner deemed appropriate. Mounted to the at least one mount 34 is an upper optical assembly 31 and a lower optical assembly 32. In this illustration, the upper optical assembly 31 includes the first objective 26. The lower optical assembly 32 includes the second objective 28. Disposed between the first objective 26 and the second objective 28 is a stage 35. The stage 35 may include any one of a variety of components used for hosting the specimen 5. For example, the stage 35 may include sample chamber 10, a glass slide, a dish or another type of device that is deemed appropriate. The microscope 30 may include other components such as at least one gear mechanism, ratchets, a clamp, a lock, a motor, a servo, a controller, and on the other type of device deemed appropriate as may be known in the art (none of which are shown herein). The additional other components may be useful for positioning and reorienting at least one of the upper optical assembly 31 and the lower optical assembly 32. For example, in FIG. 3A, a mechanical focus actuator 36 is included in each of the upper optical assembly 31 and a lower optical assembly 32 and provides for fine focus and co-focus adjustment of the respective objective 26, 28. Generally, the upper optical assembly 31 and the lower optical assembly 32 are substantially similar, if not identical, to each other and therefore may be interchangeable.

Note that the illustrations provided herein signify the presence of stage 35. In reality, the illustrations merely point to where a stage would be located, and generally provide a small planar surface suspended between the objectives 26, 28. It should be recognized that the stage 35 will include hardware and various components that are known in the art and not depicted herein. Accordingly, the illustrations provided herein are not to be construed as limiting of the microscope 30.

The frame 33 maybe oriented to any orientation deemed appropriate to make observations of the specimen 5. For example, the microscope 30 may be constructed or oriented for horizontal operation such that the observation axis and light sheet axis define a horizontal plane (as in FIG. 1). These systems often have a liquid-filled sample chamber with the sample supported in a transparent capillary or agar substrate vertically at the focus of the objectives in the center of the chamber. Alternatively, the microscope 30 may be constructed or oriented for vertical operation such that the observation axis and light sheet axis define a vertical plane (as in FIG. 2). One reason to use a vertical orientation is to allow the specimen 5 to be held in a simple dish or on a traditional microscope slide or cover-slip. In this configuration, matching of the refractive index the specimen 5 may be accomplished by use of objectives 26, 28 that are configured for water immersion, and by maintaining water held in a dish surrounding the specimen 5 and the lenses of the objectives 26, 28. For the simplest mounting of the specimen 5, where the specimen 5 is large and flat, for instance cells cultured on a cover-slip or a tissue slice on a slide, there may be further restriction on the geometry of the objectives 26, 28. Specifically, it may be required that the outside edges of objectives 26, 28 span less than 180 degrees, and that the objectives 26, 28 can co-focus on the slide without interference from the edges of the objectives 26, 28 with the bottom of the slide or dish.

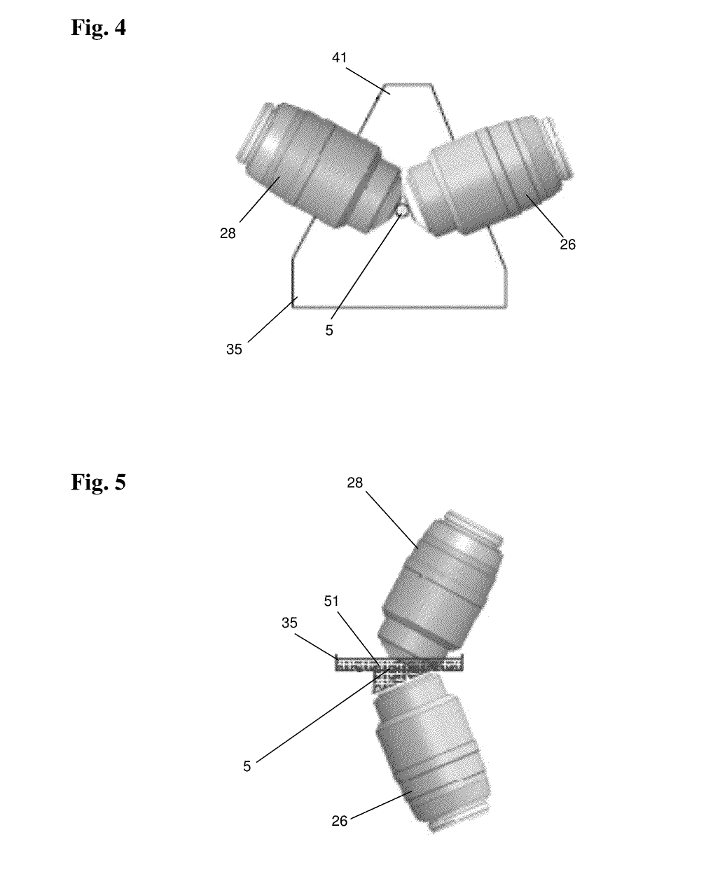

FIGS. 4 and 5 depict different orientations of the objectives 26, 28 in relation to the stage 35 and the specimen 5. In FIG. 4, the microscope 30 is configured for a horizontal implementation. The stage 35 includes a fluid box 41. In FIG. 5, the microscope 30 is configured for a vertical implementation. In this example, the stage 35 includes a coverslip and dish with water 51.

The dual-view oblique geometry can be arranged either horizontally or vertically. In the horizontal geometry, the sample mounting and chamber arrangement is very similar to geometries that place the two objectives at right angles (as shown in FIG. 4). In the vertical geometry, the sample can be held on a cover-slip placed between the two objectives (as shown in FIG. 5). In this embodiment, the second objective 28 may be a water immersion type that looks through the cover-slip while the first objective 26 is a water dipping type for looking directly at the specimen 5. The dish bottom can also be made out of plastic with refractive index near that of water, (e.g. fluorinated ethylene propylene (FEP)), so that identical water dipping objectives can be used for both lenses without refractive compromise due to the dish.

During operation of the microscope 30, the first objective 26 and the second objective 28 are placed at an oblique angle to one another such than the angle, O, between the two objectives is provided according to Eq. (3):

O≦90+I_{O}−I_{S} (3);

where I_{O} represents the included half-angle of the light cone for the objective projecting the light sheet, and I_{S} represents the included half-angle of the Gaussian light sheet beam. Adhering to the requirement of Eq. (3) ensures that there is sufficient solid angle in the light-sheet-producing objective to generate a light sheet perpendicular to the observation objective. This relationship is depicted graphically in FIG. 3B.

FIG. 3B depicts an exemplary geometry for the objectives 26, 28. In this example, the illumination objective is the first objective 26, while the observation objective is the second objective 28. In this illustration, the light sheet half-angle, I_{S}, is perpendicular to the observation objective. In this example, the objectives 26, 28 have a numerical aperture (NA)=1.1, and the oblique angle, O, is one-hundred and thirty (130) degrees. As illustrated, this method uses a portion of the solid angle of the illumination objective which is not along the optical axis of the objective. Doing so significantly relaxes the constraint to be able to co-focus the two objectives for light sheet microscopy.

The dual oblique-view single plane illumination microscope 30 maintains the advantage of prior art perpendicular dual view implementations, which includes: near-isotropic improved resolution in fused and de-convolved images and rapid multi-view imaging without requiring rotation of the sample. The oblique angle of the two high numerical aperture (NA) objectives 26, 28 allows the two objectives to jointly observe more of the specimen 5 than with the perpendicular arrangement. The use of larger numerical aperture (NA) objectives is better for collection of light than is possible with objectives that are constrained to fit together perpendicularly. Additionally, using objective lenses with numerical aperture (NA)>1.0 allows for high optical resolution. That is, use of objectives with numerical aperture (NA)>1.0 provides for a system that exceeds the resolution capabilities of the prior art dual-view light sheet microscope with two objectives of numerical aperture (NA)=0.8. (See Table 1).

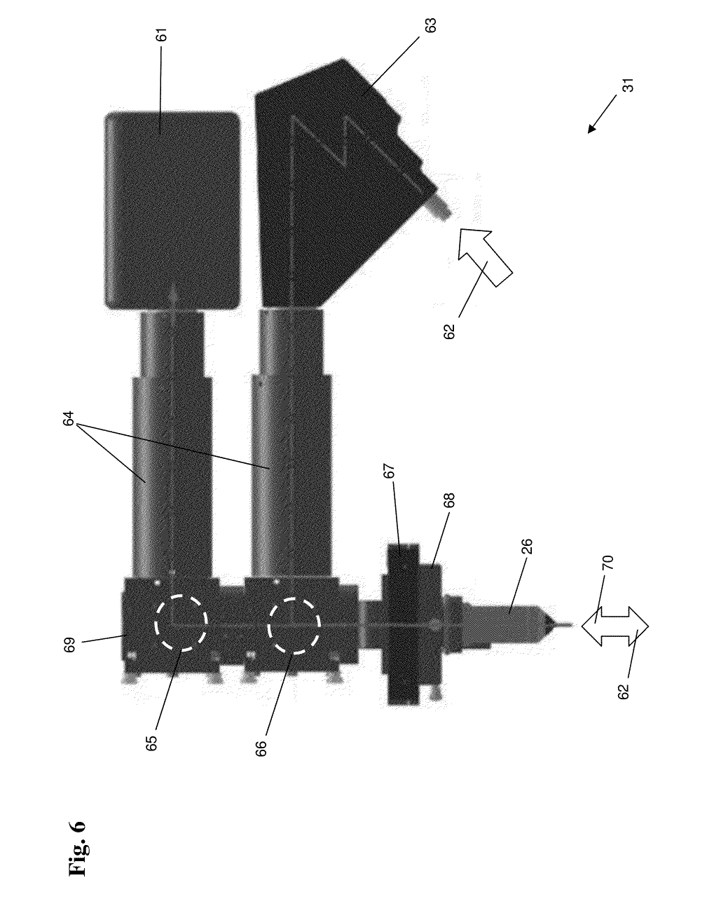

Referring now to FIG. 6, aspects of an exemplary embodiment of the upper optical assembly 31 are shown. Again, generally, the upper optical assembly 31 and the lower optical assembly 32 are substantially similar, if not identical, to each other and therefore may be interchangeable. Accordingly, the introduction of components of the optical assembly is provided with reference to the upper optical assembly 31 only. The lower optical assembly 32 includes substantially similar or identical components.

The upper optical assembly 31 includes a camera 61, an excitation scanner 63, a lens assembly 64 (for each one of the camera 61 and the excitation scanner 63), the body 69 and then objective sub-assembly. Generally, the objective sub-assembly includes a piezo-electric focus actuator 67, and transverse objective adjuster 68, and the objective 26. In this example, the camera 61 and the excitation scanner 63 are located perpendicular to the objective sub-assembly. A perpendicular orientation of the camera 61 and the excitation scanner 63 in relation to the objective sub-assembly is merely illustrative and is not limiting. That is, the camera 61 and the excitation scanner 63 may be disposed at any angle relative to the objective sub-assembly that is deemed appropriate by a user, manufacturer, designer, or other similarly interested party.

Disposed within the body 69 are at least two optical elements. The first optical element 65 provides for reflection of an optical signal to a distal component, in this case the camera 61. The second optical element 66 provides for reflection of the optical signal to a proximal component, in this case the excitation scanner 63. The second optical element 66 also provides for transmission of the optical signal to the camera 61. In some embodiments, the first optical element 65 includes a minor, while the second optical element 66 includes a dichroic beam splitter.

Note that the terms “distal” and “proximal” is used to describe the optical elements are with relation to the objective sub-assembly. It should be further noted that the geometric arrangement is merely for purposes of illustration and is not limiting of the design of the upper optical assembly 31 (or, for that matter, of the lower optical assembly 32).

The piezo-electric focus actuator 67 is used for fine focus and co-focus adjustment of the objective lenses. In some embodiments, mechanical focus actuators 36 may be used for the same purpose.

The objective adjuster 68 generally provides for translation and transverse adjustment of the objectives 26.

Generally, the excitation scanner 63 receives a light beam 62. The light beam 62 may be generated by any source deemed appropriate. Exemplary sources of illumination include a laser, and may provide a Gaussian light sheet beam. The excitation scanner 63 in conjunction with the respective lens assembly 64 (as well as other optical elements, such as those discussed above), may focus, amplify, and otherwise modify the light beam 62. Accordingly, the upper optical assembly 31 is configured to illuminate the specimen 5 with light beam 62.

When the upper optical assembly 31 is illuminating the specimen 5, the lower optical assembly 32 performs observation of the specimen 5. The roles of illumination and observation may be switched between the upper optical assembly 31 and the lower optical assembly 32 in a rapid fashion. That is, while the upper optical assembly 31 is illuminating the specimen 5, the lower optical assembly 32 performs observation of the specimen 5 for a defined interval. At the expiration of the interval, the lower optical assembly 32 provides illumination of the specimen 5, and the upper optical assembly 31 performs observation of the specimen 5.

Generally, the process of providing illumination and performing observation occurs at a rapid pace. That is, in some embodiments, the rapid switching provides for what may be effectively construed as simultaneous illumination and observation of the specimen 5. More specifically, although the objective 26, 28

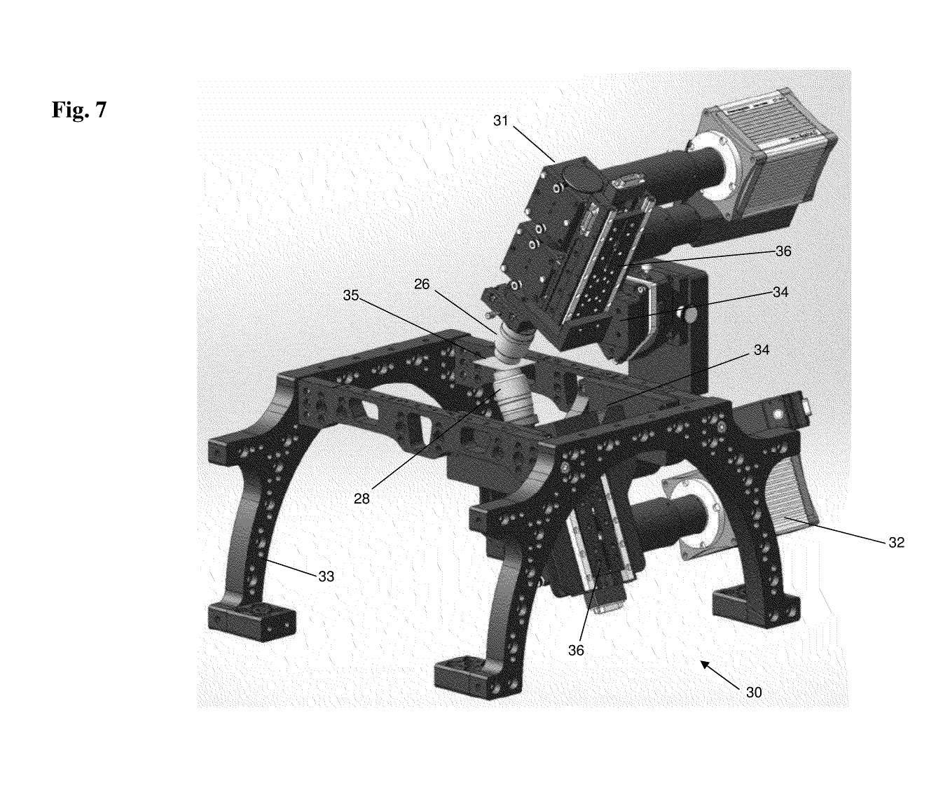

FIG. 7 provides a perspective view of aspects of the microscope 30. FIG. 7 provides another perspective that illustrates a separate mount 34 for each optical assembly 31, 32. Accordingly, the user is facilitated with adjusting the included half-angle of the light cone for the objective projecting the light sheet, I_{O}, and the included half-angle of the Gaussian light sheet beam, I_{S}.

In an exemplary embodiment, the microscope 30 includes optics to produce light sheets, either with a scanned Gaussian beam of appropriate numerical aperture, or static light sheets using cylindrical lenses. A means to position the aperture of the light sheet beam properly in the objective back focal plane of the illuminating objectives, such that the beams are tilted perpendicular to the optical axis of the observation objectives. Image-forming tube lenses and cameras to record images from the observation objectives.

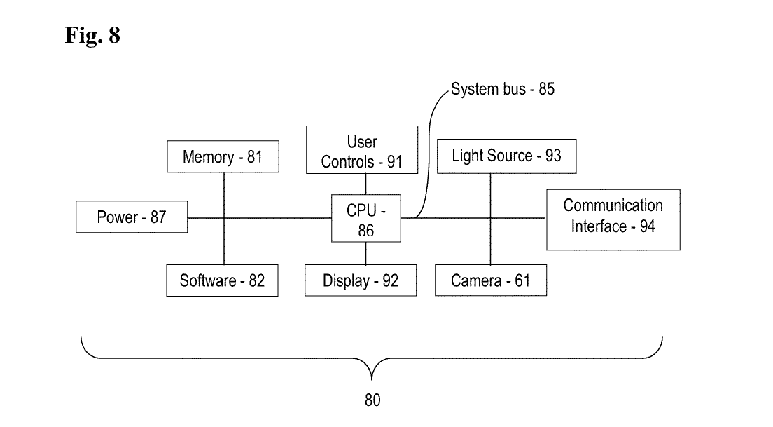

FIG. 8 depicts aspects of a control system 80. The control system 80 is configured for controlling the microscope 30. The control system 80 depicted includes some of the components that may be implemented for controlling the microscope 30. Included in the control system 80 is at least one central processing unit (CPU) 86. The central processing unit (CPU) 86 is connected to or in communication with other components through system bus 85. Other components may include a power supply 87, memory 81, software 82, user controls 91, a user display 92, camera 61, a light source 93, and a communication interface 94.

The CPU 86 may be an ARM or other processor. The power supply 87 may be from a battery or a source of direct current (DC), such as a transformer coupled to a conventional alternating current (AC) outlet. User controls 91 may include a keyboard, pointing device, a touchpad and other similar devices. The user display 92 may include at least one of LCD, LED, OLED, AMOLED, IPS and other technologies.

The communication interface 94 may include a wired interface and/or a wireless interface. The wireless interface may include a wireless service processor. Illustrative wireless interfaces may make use of a protocol such as cellular, Bluetooth, Wi-Fi, near field technology (NFC), ZigBee, or other technology. Communication services provided over the wireless communication interface may include Wi-Fi, Bluetooth, Ethernet, DSL, LTE, PCS, 2G, 3G, 4G, LAN, CDMA, TDMA, GSM, WDM and WLAN. The communication interface 94 may include an auditory channel. That is, the communication interface 94 may include a microphone for receiving voice commands, and may further include a speaker. In some embodiments, the speaker may provide an auditory signal when a barcode has been read. The communication interface 94 may further include a status light or other such visual indicators.

The communication interface 94 provides for, among other things, voice communications as well as data communications. The data communications may be used to provide for communication of software and data (such as at least one image; results of analyses, and other such types of data). Communication through the communication interface 94 may be bi-directional or in a single direction.

The control system 80 may include additional components such as sensors. Sensors may include an accelerometer that provides for orientation information, position sensors to ascertain orientation of components such as the optical assemblies (31, 32) and a GPS sensor that provides for location information. The control system 80 may also include a peripheral computer interface (PCI) and communication ports.

As discussed herein, the term “software” 82 generally refers to machine-executable instructions that provide for the implementation of the methods of this disclosure that are explained below. The machine-executable instructions may be stored on machine-readable media such as memory 81. The memory 81 may be referred to as “non-transitory.” Some of the methods that may be implemented include instructions for operation of the camera 62, the light source 93, communications through the communication interface 94, and other aspects of this disclosure as discussed herein. In some of the embodiments discussed herein, the software 82 provides for controlling imaging with the microscope 30. It should be noted that the term “software” might describe sets of instructions to perform a great variety of functions.

The memory 81 may include multiple forms of memory. For example, the memory 81 may include non-volatile random access memory (NVRAM) and/or volatile random access memory (RAM). Generally, the non-volatile random access memory (NVRAM) is useful for storing software 82 as well as data generated by or needed for operation of the software 82 such as rules, configurations and similar data. The memory 81 may include read only memory (ROM). The read only memory (ROM) may be used to store firmware that provides instruction sets necessary for basic operation of the components with the control system 80.

The camera 61 may include any appropriate sensor and at least one optical element such as a lens. Generally, the camera 61 may include those components as needed to record (also referred to as “capture”) images of the specimen(s) 5 and further include photodetectors, amplifiers, transistors, and processing hardware and power management hardware. Exemplary camera elements include at least one of: a Peltier-cooled digital camera, a phototube, an avalanche photodiode, a photomultiplier tube, a charge-coupled device (CCD), a scientific complimentary metal-oxide sensor (sCMOS) and other such devices. One suitable device for the camera 61 is sCMOS camera model Orca Flash 4.0 from Hamamatsu Corp. of Bridgewater, N.J. The camera provides for rapid acquisition of full image frames and offers a great deal of flexibility across a wide range of imaging applications. Other sensors may be used.

The light source 93 may include any appropriate source of illumination. The light source 93 may include a laser and may contain light emitting diodes (LEDs). The light source 93 may include any one or more of a plurality of lasers. Exemplary lasers include diode and diode pumped solid state lasers, commonly with wavelength 488 nm, 561 nm, 640 nm and other wavelengths.

Embodiments of objectives are available from Olympus America of Center Valley, Pa. as well as other providers. One suitable model is the XLUMPLFLN-W. This model is a high numerical aperture (NA), long working distance objective. It provides display flat images from high transmission factors up to the near-infrared region of the spectrum. These objectives achieve excellent differential interference contrast and fluorescence from the visible range to infrared. These objectives allow the measurement of cell membrane electric potential as the design of the objectives provides easy access to patch clamp electrodes. Objectives may be best suited for a particular wavelength or band of wavelengths, and may operate in any region of the electromagnetic spectrum deemed appropriate (IR, NIR, VIS, UV, etc.). Objectives may include filtration and other devices as deemed appropriate.

The control system 80 may be provided as a personal computer (PC), a dedicated or specialized device, a tablet computer, a smartphone, or as any other type of device capable of providing the intended functionality. The control system 80 may include a user interface at one location, and remote processing at another location.

In some embodiments, the control system 80 provides for controlling operation of the microscope. In some further embodiments, the control system 80 provides for recording image data collected by the camera 61 and storing the image data. The control system 80 may further construct images from the image data. The images may include two-dimensional (2D) images as well as three-dimensional (3D) images.

Having introduced the microscope 30, some additional aspects and embodiments are now presented.

A great variety of configurations of the microscope 30 may be practiced. That is, a variety of orientations of elements, mechanical components such as those for mounting of assemblies, and subassemblies may be included. Mechanical components that may be used for adjusting orientation of the various optical elements include conventional mounting systems, swing-arm mounts, rack mounts, fixed mounting systems, and other such systems. In short, the at least one mount 34 may contain components as considered appropriate for moving components of the microscope 34 within three-dimensional space.

The microscope 30 may include various sensors configured to sense position and/or orientation of the various optical assemblies. The sensors may provide position and/or orientation information to a controller (not shown). The controller may use the position information for a variety of purposes, including construction of three-dimensional images of a given specimen 5.

Additionally, the various components described herein may include a variety of optical elements and sub-elements.

Various electro-optic elements of the microscope 30 may include an interface for a power supply, a communications interface, a controller interface and other forms of external interfaces.

In some embodiments, the microscope 30 includes at least another optical assembly. The at least another optical assembly may provide for illumination and/or observation.

In some embodiments, optical assemblies, such as the upper optical assembly 31 described above, may be provided as a part of the kit. The kit may include the at least one mount 34. Collectively, the kit may provide for retrofit of existing, prior art, microscope. For example, the kit may include a mounting system that is configured for fitting to a prior art microscope frame. Additionally, optical assemblies within the kit may be configured for making use of parts on the prior art microscope. For example, the kit may be designed for making use of a laser or other light source and the prior art microscope.

In some embodiments, the stage 35 is configured to translate relative to the objectives 26, 28, and may move in three-dimensional space.

Various other components may be included and called upon for providing for aspects of the teachings herein. For example, additional materials, combinations of materials and/or omission of materials may be used to provide for added embodiments that are within the scope of the teachings herein.

For purposes of convention and to aid in the discussion herein, relative terminology may be used. For example, terms of orientation are provided with regard to the figures. For example, orientation of one component in relation to another component, may be described as upper, lower, forward, proximal, distal and by other such terminology. Similarly, terms of ranking may be used to describe the various elements. For example, elements may be referred to as a first, a second, a third and so on. Again, the foregoing structures and descriptions are not to be construed as limiting of the teachings herein.

Standards for performance, selection of materials, functionality and other discretionary aspects are to be determined by a user, designer, manufacturer or other similarly interested party. Any standards expressed herein are merely illustrative and are not limiting of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. As used herein, the term “exemplary” is not intended to imply a superlative example. Rather, “exemplary” refers to an embodiment that is one of many possible embodiments.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A microscope comprising:
an optical assembly comprising a first objective; and,
another optical assembly comprising a second objective;
wherein the first objective and the second objective are configurable to be oriented in an oblique angle relative to each other to provide for illumination and observation of a specimen.

2. The microscope is in 1 configured for performing selective plane illumination microscopy.

3. The microscope is in 1, wherein the first objective and the second objective alternate between providing the illumination and performing the observation.

4. The microscope as in 1, wherein the oblique angle, O, between the first objective in the second objective is described by the following relationship:
O≦90+I_{O}−I_{S};
where I_{O} represents the included half-angle of a light cone for the objective providing the illumination, and I_{S} represents the included half-angle of the light beam providing the illumination.

5. The microscope as in 4, wherein the included half-angle of the light cone, I_{O}, is between 12.9 degrees and 63.6 degrees.

6. The microscope as in 4, wherein the included half-angle of the light beam, I_{S}, is between 1.29 degrees and 23.58 degrees.

7. The microscope as in 1, wherein a numerical aperture (NA) of at least one of the first objective and the second objective is greater than 0.948.

8. The microscope as in 1, wherein a beam waist radius is in the range of 0.5 micrometers to 9.2 micrometers.

9. The microscope as in 1, wherein a beam range is in the range of 3.5 micrometers to 1072.7 micrometers.

10. The microscope as in 1, further comprising a controller configured for at least one controlling operation of the microscope and performing imaging with the microscope.

11. A method for fabricating a microscope, the method comprising:
selecting a frame; and,
incorporating an optical assembly comprising a first objective and another optical assembly comprising a second objective; and,
configuring the first objective and the second objective to be oriented in an oblique angle relative to each other to provide for illumination and observation of a specimen.

12. The method as in 11, wherein at least one optical assembly comprises: a camera, an excitation scanner and an objective sub-assembly.

13. The method as in 12, wherein the objective sub-assembly comprises an objective comprising a numerical aperture (NA) that is greater than 0.948.

14. The method as in 12, wherein at least one optical assembly comprises: a body to which the camera and the excitation scanner are mounted.

15. The method as in 14, wherein the body comprises at least one reflective element and at least one dichroic element.

16. The method as in 12, wherein at least one optical assembly comprises: a body to which the camera and the excitation scanner are mounted.

17. A controller for a microscope, the controller comprising:
a set of computer executable instructions stored on non-transitory computer readable media, the instructions for operating an optical assembly comprising a first objective and another optical assembly comprising a second objective; and orienting the first objective and the second objective in an oblique angle relative to each other to provide for illumination and observation of a specimen.

18. The controller as in 17, wherein the oblique angle, O, between the first objective in the second objective is described by the following relationship:
O≦90+I_{O}−I_{S};
where I₀ represents the included half-angle of a light cone for the objective providing the illumination, and I_{S} represents the included half-angle of the light beam providing the illumination.

19. The controller as in 17, further comprising instructions for at least one of collecting and storing image data.

20. The controller as in 17, further comprising instructions for generating an image from image data.
